(19) United States
(12) Patent Application Publication
(10) Pub. No.: US 2012/0000536 A1
(43) Pub. Date: Jan. 5, 2012

(54) Portable fluid transfer system

(76) Inventors: Dan Rodie Marich, Peoria, AZ (US); Robert David Stahl, Cottonwood, AZ (US)

(21) Appl. No.: 13/068,711

(22) Filed: Aug. 11, 2011

Related U.S. Application Data
(60) Provisional application No. 61/397,979, filed on Jun. 18, 2010.

(51) Int. Cl. F15D 1/00

(52) U.S. Cl. 137/1; 137/565.01

(57) ABSTRACT

This (Portable Fluid Transfer System) is designed to displace a volume of water that will satisfy a small residence under normal or abnormal conditions. This unit has a unique feature described as an ECU which will balance (float) the battery charge when necessary, allowing the battery to be charged from various sources and operating the pump while charging is in effect. This component also sustains the battery life by not allowing the battery to overcharge. Although float circuitry is not new, it is unique within portable electric pump systems. This amendment contains no new matter.

This application claims benefit of Provisional Application No. 61/397,979 filed on Jun. 18, 2010

### BRIEF DESCRIPTION OF THE DRAWINGS

FIG. 1 is a perspective view of a transfer system constructed in accordance with the teachings of the instant invention;

FIG. 2 is an enlarged view of a coupler useful in connection with the fluid transfer system;

FIG. 3 is a front elevation view;

FIG. 4 is the left end elevation view;

FIG. 5 is the right end elevation view;

FIG. 6 is a horizontal sectional view taken along the line 6-6 in FIG. 3;

FIG. 7 is a front elevation view having a fragmentary section removed;

FIG. 8 is a vertical sectional view taken along the line 8-8 in. FIG. 6; and

FIG. 9 is a vertical sectional view taken along the line 9-9 in FIG. 6.

FIG. 10 is an internal schematic view as seen in FIG. 7;

### DETAILED DESCRIPTION OF THE PREFERRED EMBODIMENT

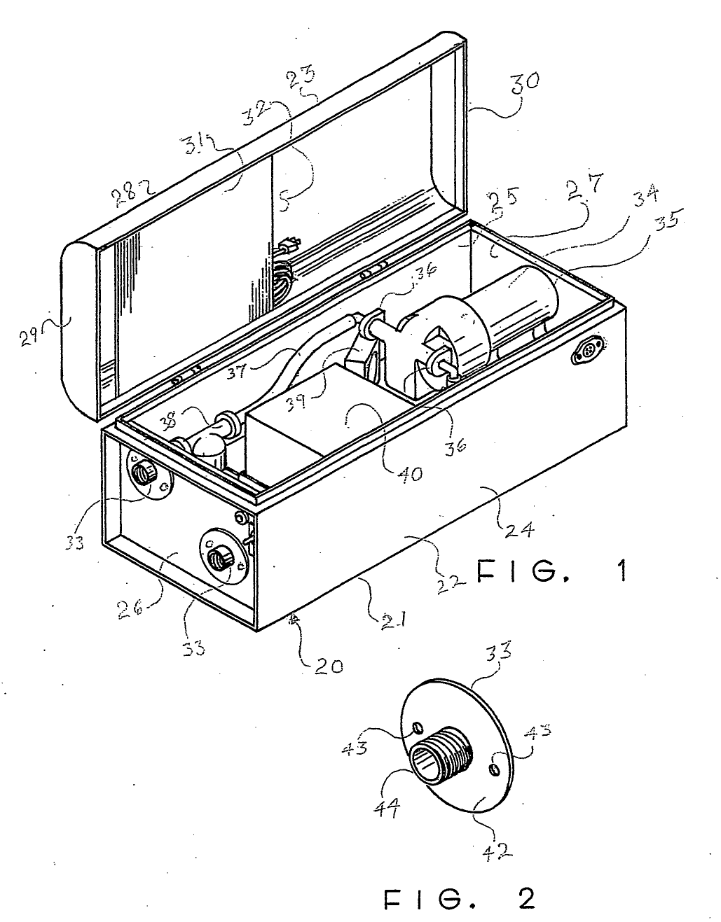

Turning now to the drawings, in which like reference characters indicate corresponding elements throughout the several views, attention is first directed to FIG. 1 in which is seen a fluid transfer system embodying the principles of the present invention and generally designated by the character 20. Fluid transfer system 20 includes container 21 having base unit 22 and lid 23. Base 22, includes front panel 24, rear panel 25 and left end panel 26 and right end panel 27. Although not specifically seen in FIG. 1, it is understood that base unit 22 also includes a bottom panel. Lid 23 includes convex top panel 28, left end panel 29 and right end panel 30.

With continued reference to FIG. 1, it is seen that plate 31 carried within lid 23 and affixed to spaced apart segments of convex top panel 28 defines storage space 32 couplers 33 are carried by left end panel 26. System assembly 34 resides within base unit 22. System assembly 34 is seen a pump 35, pump connecter kit 36, tube 37 and filter kit 38 along with fan 39 and power supply 40.

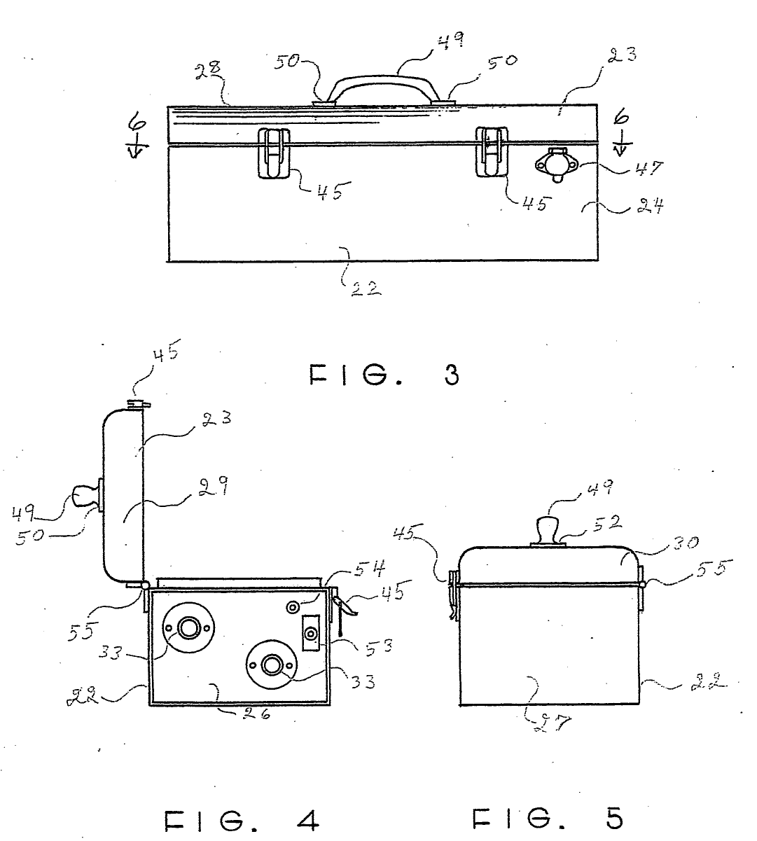

Referring now to FIG. 2 is seen that each coupler 33, includes mounting plate 42 having openings 43 for receiving a mechanical fastening device, such as a rivet or a screw, for attachment to left end panel 26. Nipple 44 is carried by mounting plate 33. It is noted that left end panel 26 is recessed in order to shield couplers 33.

The front view in FIG. 3 is seen base unit 22 connecting lid 23 with latches 45. Also mounted on plate 24 is seen receptacle 47 with openings 48 allowing for a mechanical connection as described in FIG. 2. Continuing along FIG. 3, is seen the front view of a handle 49 connected to the top of convex plate 28 at handle ends 50 with openings 52 for mechanical connectors as depicted in FIG. 2.

As shown in the left end elevation FIG. 4 is plate 26 affixed with couplers 33, on/off switch 53 and light 54. The lid 23 is shown in the open position viewing left lid panel 29, latch 45, handle 49, handle left end 50 and left side view of hinge 55 connecting lid 23 and base unit 22. Also affixed to base unit 22 is latch 45.

Right end elevation FIG. 5 is shown with lid closed. Panel 27, of base unit 22, panel 30 of lid 23, handle 49 and right handle end 52 are seen. Connecting base 22 with lid 23 is seen hinge 55 and latch 45 both in closed position.

Proceeding now to sectional view FIG. 6, the system assembly 34 becomes readily visible. Following the top arrow, now described as fluid inlet 58 which gives a direction of fluid flow and allows the interior side of coupler 33 to be seen with nipple 57 supplied with filter kit 38 such as model 254 from Shurflo pumps. Continuing along this direction is a flexible tube 37 tied to Shurflo elbow such as 84-920-02 denoted by 36, which connects to a pump such as Shurflo model 5.7 pump 35.

At this time the direction of flow is reversed leaving pump 35 through another elbow 36, flexible tube 37 and ending at coupler 33 on left end plate 26 and outlet direction arrow 59.

Further examination of FIG. 6 reveals a fan 39 such as Jameco 136143cm partially hidden by pump 35 and a thermostat switch 62 such as Stancor stc-120 attached to the base of pump 35 shown with dashed lines and tied to fan 39 by way of wiring harness 60. Harness 60 in FIG. 6 connects the electrical parts together, starting with rechargeable battery 40 connecting at positive pole 62 and negative pole 63. Leaving battery connections the wires are now connected to on/off switch 53, light 54 and pump 35. The same harness is seen connecting the internal charging system 63 and later referred to as the (ECCU), the receptacle 47, fan 39 and thermal switch 62.

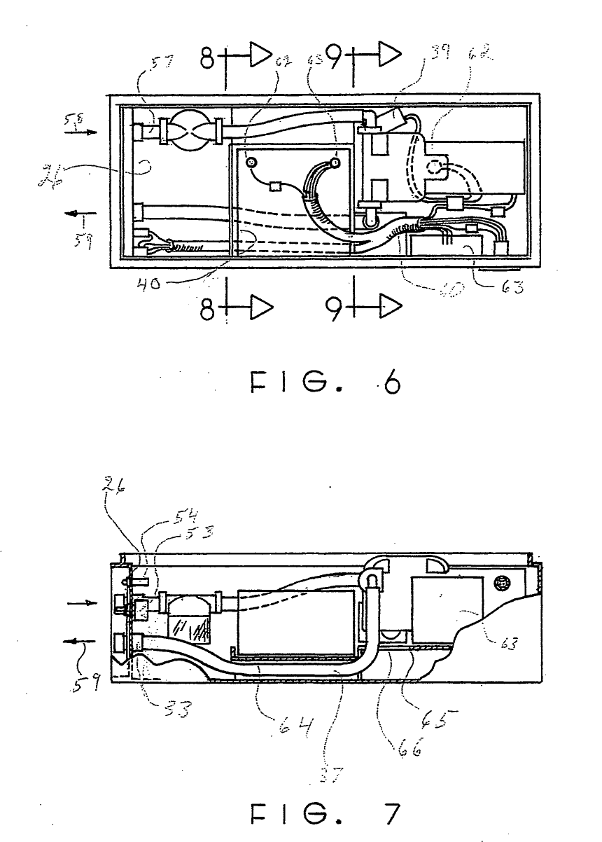

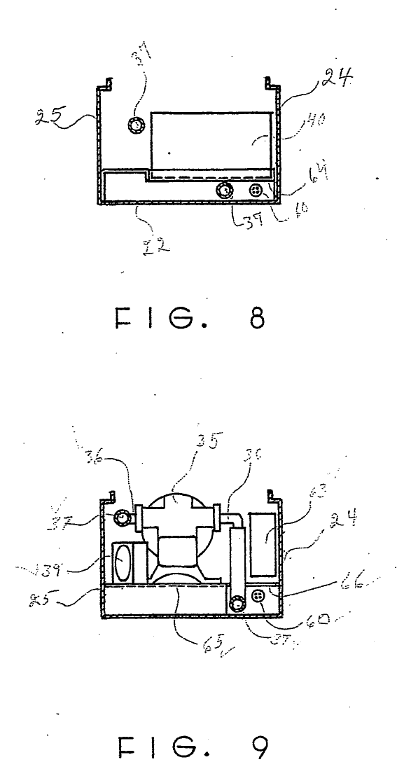

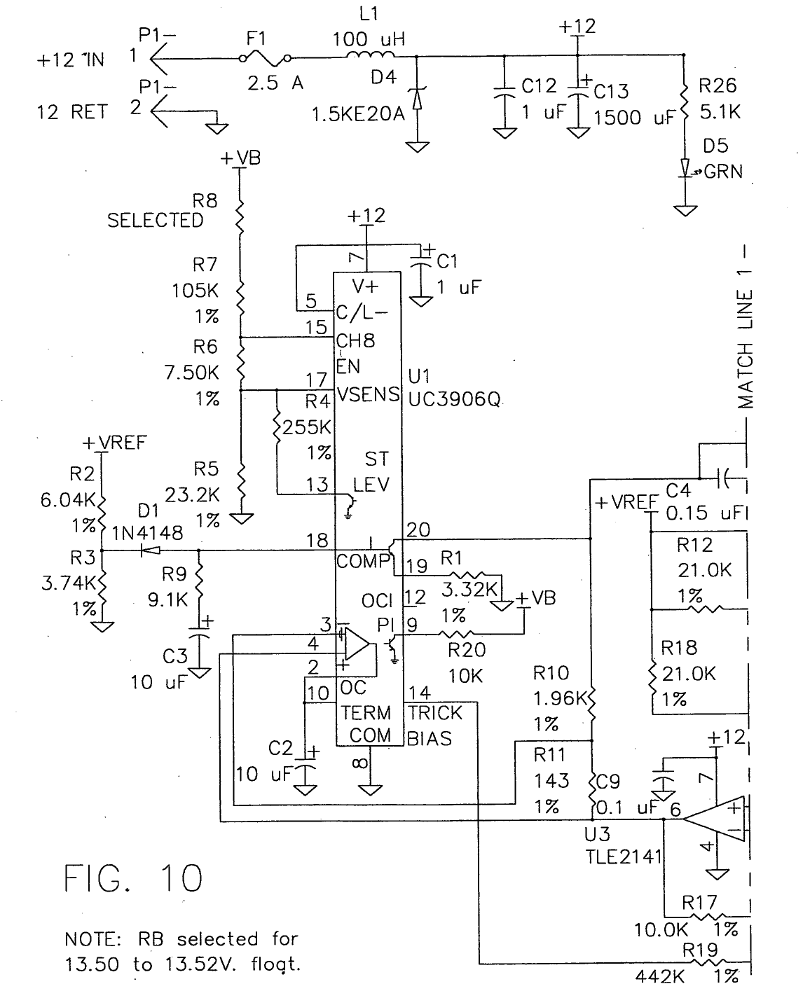

Now directing attention to FIG. 7, which allows shelf 64 and shelf 65 to be exposed. Also exposed at this angle is slot 6 through which is seen tube 37 passing through in outlet direction 59 and under shelf 64. Also depicted is coupler 33, switch 53 and light 54 passing through and connected to plate 26. The eccu 63 can also be seen and it's location within container 21 better determined along with battery 40.

Turning to FIG. 8 there is seen a view taken along line 8-8 of FIG. 6 that gives an unobstructed sectional view of tube 37 along fluid inlet direction 58 and tube 37 along fluid outlet direction 59 passing under power supply shelf 64 and above base 22. Also seen is power supply 40, vertical front panel 24 and rear panel 25.

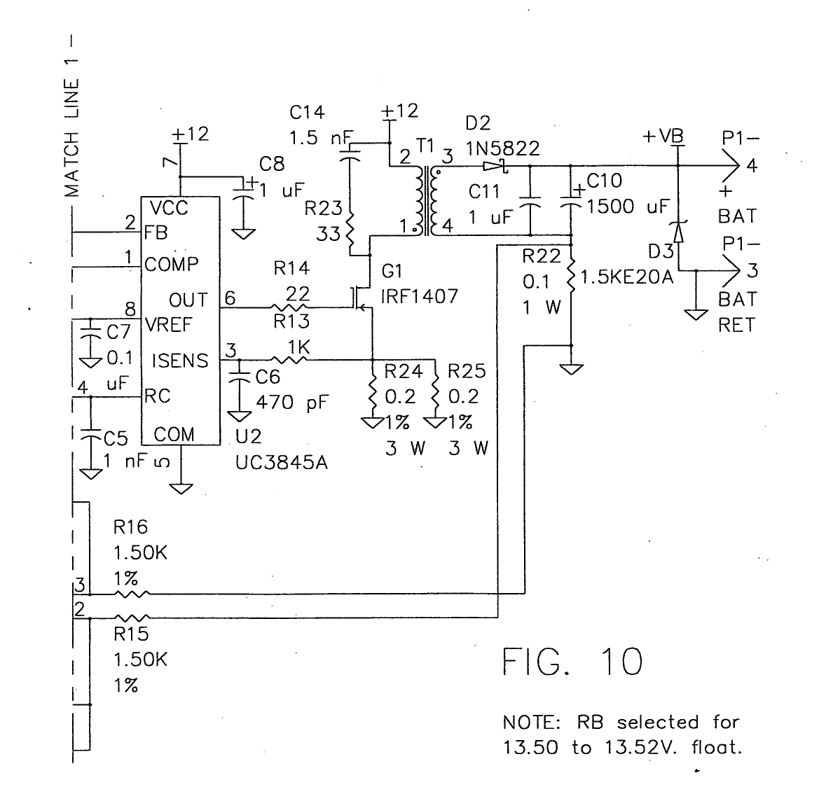

Maintaining attention on FIG. 6 along line 9-9 gives an unobstructed view of shelf 65 with attached items fan 39, pump 35, and eccu 63. Within FIG. 9 can be seen elbow connector kit 36 described in FIG. 6, flexible tube 37, wiring harness 60, and slot 66.

Continuing attention on FIG. 9 views of 63 eccu enclosure assembly containing internal battery charging circuit FIG. 10. This circuit FIG. 10 is intended to quickly bring the installed battery 40 up to full capacity for operation. Battery charging circuit FIG. 10 consists of a T1 UC3906 (U1) linear lead- acid battery such as MK model M12260 SLD and charging IC (integrated circuit), T1 UC3845AN (U2) (pin dual in-line package) available off the shelf at electronic stores , and PWM IC (pulse width modulation integrated circuit) with regard to DC-DC charging. TI TLE2141 (U3) (low-noise, high speed operational amplifier), and additional components in requirement for the desired operation of the eccu charging functionality. Turning to FIG. 6 can be seen a 4-pin male connector (P1), which connects to internal wiring harness 60. Maintaining attention to said connector, voltage input/output and sensing services are provided for charging functionality on pins 1, 3, and 4. Also seen is an operational LED (light emitting diode) (D5) and a replaceable fuse (F1) with regard to the safe operation of the device.

The Fluid Transfer Unit constructed in this configuration, but not restricted to can be used to transfer potable water under the most dire of conditions. With minimal changes this unit is designed to transfer various fluids and its complete portability allows it to accommodate many types of needs. It is also capable of maintaining basic and constant household water pressure when connected in series with a clean water supply for several days without recharging. Along the lines of constant household pressure this unit is a capable backup for RV's, boats, cabins and various disaster situations . Thus it must be concluded that small military applications are not without reasonable consideration due to the rugged design and complete portability.

This unit with it's onboard charger and an off the shelf ac-dc charger (supplied) with the sale of the unit allow for any type of charging conditions available. The flexibility and portability of this unit allows for the maximum array of uses.

This Portable Fluid Transfer System surpasses anything on the market today. It's ability to operate in full sun with the lid closed at high temperatures or out in the open under rainy conditions gives it an extreme flexibility. Another unique feature is the (ECCU) which is an internal charger that has been specifically designed for this use. The circuitry and connectors allow connections to any 12v power source. Depending on the connections this unit will create a charging source or while operating the system charge the onboard battery. A float circuit is also included to maintain a fully charged system when connected to an a/c source by way of an a/c to d/c charger supplied with the unit.

Although this particular design is set for potable water it's off the shelf attitude gives it the ability to transform within minutes to handle various fluids. This flexibility, which can be found in some industries, is nowhere to be found within this industry.

What is claimed is:

1. A self contained portable fluid transfer system comprised of a unique matching of filters, 12 volt on demand self priming pumps connected to an electronic control unit which allows charging of the battery from various sources at a rate of up to 2 amps.

2. The system described in claim 1 eliminates the problems of storing explosive fuels and hard wired a/c.

3. The method in claim 1 is accomplished in a custom designed container with no protruding parts which allows transport and operation under various handling and weather conditions.

4. As described in claim 1 the ECU (Electronic Control Unit) overcomes the problem of down time when charging the battery by allowing the connection of an external source, such as a solar cell or an a/c charger depending on availability.

5. The method of claim 1 supporting the plural of pumps is created by using off the shelf components with their quick connect devices to allow for various pumping pressures up to average household pressures.
